(19) United States
(12) Patent Application Publication
(10) Pub. No.: US 2025/0041970 A1
(43) Pub. Date: Feb. 6, 2025

(54) STRENGTHENING DEVICE AND PROCESSING METHOD FOR IMPROVING FATIGUE, WEAR AND CORROSION PERFORMANCE OF METALS

(71) Applicant: Air Force Engineering University, Xi'an (CN)

(72) Inventors: LIUCHENG ZHOU, Xi’an (CN); WEIFENG HE, Xi’an (CN); XINLEI PAN, Xi’an (CN); YANQING YU, Xi’an (CN)

(21) Appl. No.: 18/230,225

(22) Filed: Aug. 4, 2023

(51) Int. Cl. B23K 26/352; B23K 26/082

(52) U.S. Cl. CPC B23K 26/352; B23K 26/082

(57) ABSTRACT

Disclosed are a strengthening device and method for improving fatigue, wear and corrosion performance of metals. In the present disclosure, a femtosecond laser device, an optical transmission module, an optical platform, a five-axis mobile platform, a femtosecond laser processing head, and a central processing unit are included, where laser scanning processing is completed by means of the synergy of the five-axis mobile platform and a scanning galvanometer. A femtosecond laser processing process method for regulating and controlling shock wave pressure and surface self-organizing structure characteristics is proposed by the present disclosure, where a work-hardening layer and a wear-resistant and hydrophobic micro-nano structure are prepared on a surface of the metal in one step by means of the femtosecond laser, and simultaneous improvement of the fatigue, wear and corrosion performance of the metals is achieved.

### TECHNICAL FIELD

The present disclosure belongs to the technical field of surface strengthening of metals, and in particular to a strengthening device and a processing method for improving fatigue, wear and corrosion performance of metals.

### BACKGROUND

In modern apparatuses, most of mechanical parts are often subjected to different loading during service, such as wear loading caused by relative sliding between contact parts, fatigue loading under an action of cyclic vibration stress, and corrosion in a salt spray environment. And various loadings are coupled to each other, resulting in premature failure of metal parts. In some cases, it even causes major safety accidents such as sudden fracture, which seriously influences reliability of the apparatuses and service safety. For mechanical parts, compound damage problems caused by various loading generally exist. Being different from failure caused by a single loading, compound damage has stronger destructiveness, and damage behaviors of the parts are more complex due to coupling of various loadings. The prior art usually works only for the damage induced by a single loading. However, the strengthening effects are limited when the parts are subjected to multiple loadings. Therefore, it is urgent to develop a novel technology to solve the compound damage failure of the metal parts caused by multiple loadings.

In general, wear scar, fatigue crack and corrosion pits of the metal parts originate from the surfaces, and therefore, surface strengthening technology becomes an important means for solving this issue. Currently, there are technologies such as coating, shot peening, injection, infiltration, etc. These technologies show a good strengthening effect on solving failure of parts caused by a single loading, but are out of action for compound damage induced by multiple loadings. For example, the coating and injection/infiltration technologies can improve wear resistance of the parts well, but their fatigue performance is likely to be worse. Besides, another problem is that the coating shed often occurs in service. The laser shock peening and shot peening technologies could introduce gradient microstructure and compressive residual stress into the surface layer of materials, which provides much benefit for the fatigue performance improvement. But the effects on wear resistance are limited. Accordingly, the present disclosure provides a strengthening device and a processing method for improving fatigue, wear and corrosion performance of metals simultaneously.

### SUMMARY

An objective of the present disclosure is as follows: in order to effectively solve the compound damage problem of metal parts served in various loadings environment. The present application provides a strengthening device and a processing method for improving fatigue, wear and corrosion performance of metals.

The technical solutions employed by the present disclosure are as follows:

A strengthening device for improving fatigue, wear and corrosion performance of metals includes a femtosecond laser device, an optical transmission module, an optical platform, a five-axis mobile platform, a femtosecond laser processing head, and a central processing unit, where the optical platform is fixedly connected to a rear side face of the five-axis mobile platform, the femtosecond laser device is fixedly connected to a left side of an upper surface of the optical platform, and the optical transmission module is mounted on a right side of the upper surface of the optical platform. The five-axis mobile platform employs a single-column structure, two linear axes X/Y and two rotating axes A/Z form a carrying platform, the femtosecond laser processing head is mounted on a Z-axis saddle of the five-axis mobile platform, and a specimen is fixed on the five-axis mobile platform and is located below the femtosecond laser processing head.

In a preferred invention manner, the optical transmission module includes a beam expander, a diaphragm, a wave plate, a first reflector, a second reflector, a third reflector, and a movable focus lens.

In a preferred invention manner, a scanning galvanometer module, a fourth reflector, a fifth reflector, a laser focus position calibration module, and a visual imaging module are integrated inside the femtosecond laser processing head.

In a preferred invention manner, the visual imaging module includes a charge coupled device (CCD) camera, where an output end of the CCD camera is connected to an object-side telecentric lens by means of a fixing support, and a band-pass filter is arranged under an output end of the object-side telecentric lens.

In a preferred invention manner, the fourth reflector may transmit an annular light source of the fifth reflector, and the fourth reflector may refract laser with a working wavelength of 1030 nm.

In a preferred invention manner, the scanning galvanometer module includes a first swing motor, a second swing motor, and a dynamic focus control unit.

In summary, due to employing the above technical solutions, the present disclosure has the beneficial effects as follows:

In the present disclosure, femtosecond laser with the ultra-short pulse duration (fs level) and an ultra-high power density (TW/cm2 level) is irradiated on the surface of metals. Under the effects of extremely strong physical field induced by fs-laser, gradient microstructure and periodic micro/nano structures are fabricated on the surface. This unique structure shows a great potential in fatigue, wear and corrosion performance improvement of metals, which offers a novel strategy to solve the failure of components caused by multiple loadings.

### BRIEF DESCRIPTION OF DRAWINGS

FIG. 1 is a front view of the present disclosure;

FIG. 2 is a schematic diagram of an optical path of the present disclosure;

FIG. 3 is a schematic diagram for layout of internal modules of a femtosecond laser processing head of the present disclosure;

FIG. 4 is a schematic structural diagram of a visual imaging module of the present disclosure;

FIG. 5 is a schematic structural diagram of a laser focus position calibration module of the present disclosure;

FIG. 6 is a schematic structural diagram of a three-dimensional scanning galvanometer module of the present disclosure;

FIG. 7 is a schematic diagram of a femtosecond laser scanning path of the present disclosure;

FIG. 8 is a graph showing the results of residual stress on the surface of a specimen subjected to femtosecond laser strengthening of the present disclosure;

FIG. 9 is a graph showing an electrochemical corrosion polarization curve of aluminum alloy subjected to femtosecond laser strengthening of the present disclosure.

Reference numerals in the figures: 1—femtosecond laser device, 2—optical transmission module, 3—optical platform, 4—five-axis mobile platform, 5—femtosecond laser processing head, 6—specimen, 20—beam expander, 21—diaphragm, 22—wave plate, 23—first reflector, 24—second reflector, 25—third reflector, 26—movable focus lens, 51—scanning galvanometer module, 52—fourth reflector, 53—fifth reflector, 54—laser focus position calibration module, 55—visual imaging module, 510—first swing motor, 512—second swing motor, 513—dynamic focus control unit, 540—first lens, 541—first plane mirror, 542—second lens, 543—second plane mirror, 544—optical detector, 550—CCD camera, 551—object-side telecentric lens, 552—band-pass filter, and 553—laser.

### DETAILED DESCRIPTION

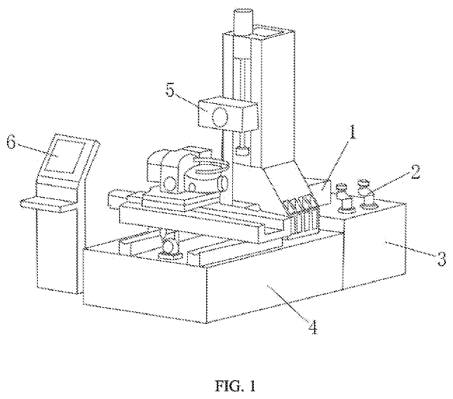

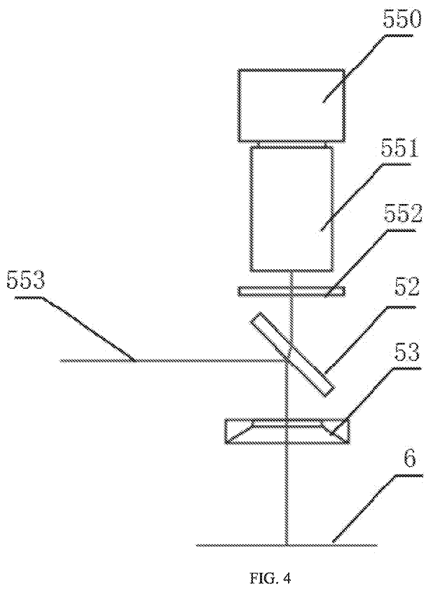

A strengthening device and a processing method for improving fatigue, wear and corrosion performance of metals in an example of the present disclosure will be described in detail with reference to FIGS. 1-9.

### EXAMPLES

With reference to FIG. 1, a strengthening device and a processing method for improving fatigue, wear and corrosion performance of metals are provided. The device includes a femtosecond laser device 1, an optical transmission module 2, an optical platform 3, a five-axis mobile platform 4, a femtosecond laser processing head 5, and a central processing unit, where the five-axis mobile platform 4 employs a single-column structure, two linear axes X/Y and two rotating axes A/Z form a carrying platform, and therefore, four-degree-of-freedom motion of a specimen is achieved, and the Z axis drives the processing head to process the specimen. The optical platform 3 is fixedly connected to a rear side face of the five-axis mobile platform 4, the femtosecond laser device 1 is fixedly connected to a left side of an upper surface of the optical platform 3, and the femtosecond laser device 1 outputs a femtosecond laser source, and acts on the surface of the specimen after optical path shaping, focusing and other optical path conversion so as to achieve high-frequency femtosecond laser processing.

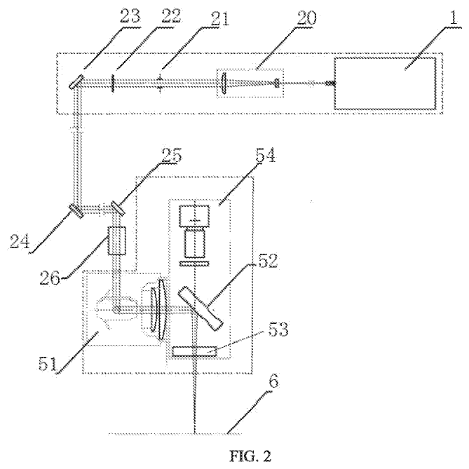

With reference to FIG. 2, the optical transmission module 2 is mounted on a right side of the upper surface of the optical platform 3, and the optical transmission module 2 adjusts parameters of a laser beam according to design requirements, and accurately transmits the laser beam to the laser high-speed scanning module to achieve processing. The optical transmission module 2 includes a beam expander 20, a diaphragm 21, a wave plate 22, a first reflector 23, a second reflector 24, a third reflector 25, and a movable focus lens 26. The laser beam emitted from the femtosecond laser device 1 is expanded by the beam expander 20 and then enters the diaphragm 21 to remove stray light, linearly polarized laser is adjusted to circularly polarized light by means of the ¼ wave plate 22, and a spatial position and orientation are adjusted by the first reflector 23, the second reflector 24, and the third reflector 25.

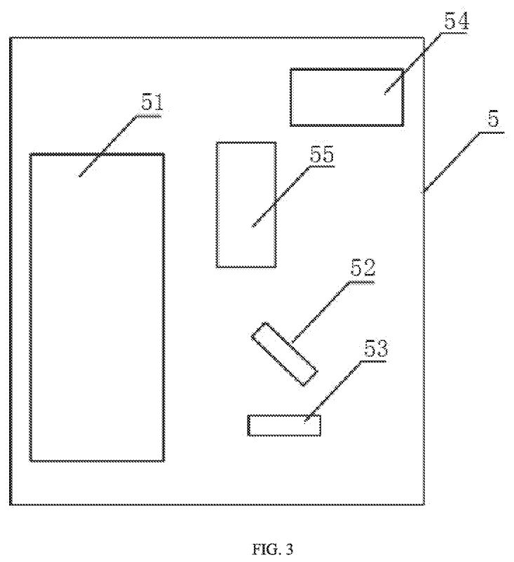

With reference to FIG. 2 and FIG. 3, a femtosecond laser processing head 5 is mounted on a Z-axis saddle of the five-axis mobile platform 4, and the femtosecond laser processing head 5 is driven by the Z axis to move up and down and be positioned. A scanning galvanometer module 51, a fourth reflector 52, a fifth reflector 53, a laser focus position calibration module 54, and a visual imaging module 55 are integrated inside the femtosecond laser processing head 5. After being focused by the movable focus lens 26, the femtosecond laser enters the scanning galvanometer module 51 of the femtosecond laser processing head 5 and then is focused on the surface of a specimen 6 by means of the fourth reflector 52 and the fifth reflector 53, and indication red light of laser focus position calibration module 54 coupled in the optical path is used for alignment position reference during femtosecond laser strengthening. Moreover, the femtosecond laser processing head 5 is integrated with the scanning galvanometer module 51, the laser focus position calibration module 54 and the visual imaging module 55, such that the system has the capability of processing the parts with three-dimensional curved surface, and monitoring and calibrating mutual positions of laser spot and the specimen during processing.

With reference to FIGS. 2-4, the visual imaging module 55 includes a CCD camera 550, an output end of the CCD camera 550 is connected to an object-side telecentric lens 551 by means of a fixing support, a band-pass filter 552 is arranged under an output end of the object-side telecentric lens 551, and a working wavelength of the band-pass filter 552 is selected at 600-700 nm. The CCD camera 550 is directly connected to the object-side telecentric lens 551, the object-side telecentric lens 551 is fixed by a supporting frame, a distance between the lens and a working surface may be adjusted and then locked, and a processing surface zone is observed and monitored by means of the reflector. The fourth reflector 52 may transmit an annular light source of the fifth reflector 53, the fourth reflector 52 may refract laser 553 with a working wavelength of 1030 nm, the annular light source of the fifth reflector 53 is arranged between the large-format fourth reflector 52 and window glass, LED light is irradiated on the specimen 6, and the fourth reflector 52 may reflect the laser 553 with the working wavelength of 1030 nm and transmit the annular laser source of the fifth reflector 53.

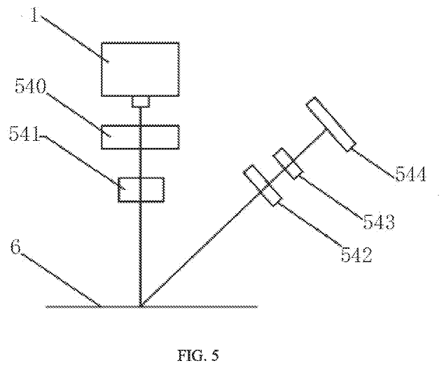

With reference to FIG. 2, FIG. 3 and FIG. 5, the red indication light coincides with the position of the laser focus for processing, and the visual imaging module 55 is used for real-time monitoring, and may be used for rapid calibration of the focus position of the femtosecond laser and real-time monitoring of the mutual position between the focused spots and the specimen 6 during processing. An included angle between the laser and the working optical axis is less than 10°, the processing laser beam passes through a first lens 540 and a first plane mirror 541 to act on the surface of the specimen 6, the reflected laser beam passes through a second lens 542 and a second plane mirror 543 to reach an optical detector 544, and the optical detector 544 collects an optical signal to calculate the laser focus position.

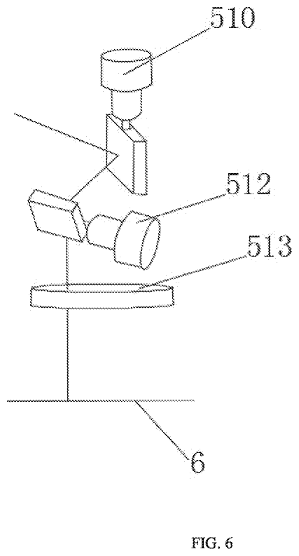

With reference to FIG. 2, FIG. 3 and FIG. 6, the three-dimensional scanning galvanometer includes two special first swing motors 510, a second swing motor II 512 and a dynamic focus control unit 513, a reflector is clamped at a shaft end of the motor, torque is generated in a magnetic field after a motor coil is electrified, reset torque is increased on a motor rotor by means of a torsion spring or an electronic method, and the magnitude is in direct proportion to an angle of the rotor deviating from a balance position. When a position signal is input from a controller, the motor in the galvanometer swings by a certain angle according to a certain voltage and angle conversion ratio. The whole process uses closed-loop feedback control, and is jointly implemented by a position sensor, a comparison amplifier, a power amplifier, a position discriminator, a current integrator, etc. The laser beam enters the galvanometer to be irradiated on the reflector, and the orientation is changed. A high-speed rotating motor may enable the laser beam to form a two-dimensional scanning path.

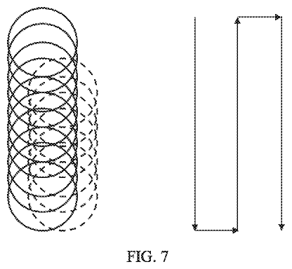

Before femtosecond laser processing, the surface of the 7075 aluminum alloy specimen 6 is ground and polished, such that surface roughness Ra is reduced to below 0.2, and then the specimen is placed in an absolute ethyl alcohol solution for ultrasonic cleaning for 5 minutes. During femtosecond laser processing, firstly, the femtosecond laser 1 is started for preheating for 15 minutes, where the pulse duration is 290 fs, and input laser parameters are as follows: laser energy is 50 μJ, 100 μJ, 150 μJ and 200 μJ, the spot diameter is 15 μm, the repetition is 50 kHz, and an interval of adjacent laser spots is 5 μm. The size data of a processing zone is input into proprietary software, where the rectangular processing zone is 4 cm*2 cm, and a laser scanning path is automatically generated in the system. Then, the specimen 6 is fixed on the processing platform, and the laser focus position is adjusted to the surface of the specimen 6 by controlling the movement of Z axis, such that a starting point of a zone to be processed of the specimen 6 coincides with the position of a red indication light. Then a key of operation is clicked to start femtosecond laser processing, the laser processing scanning path is zigzag as shown in FIG. 7, and whether the laser scanning path satisfy an expectation or not is watched during processing.

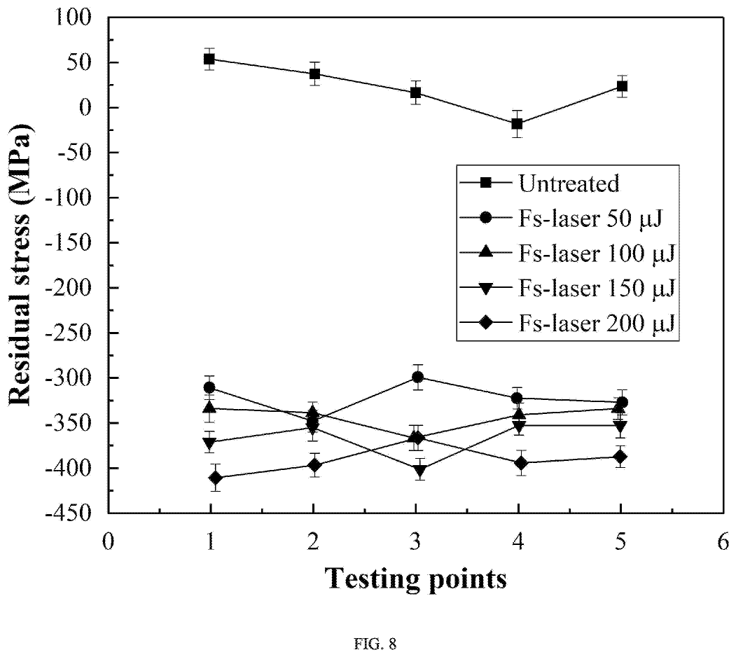

With reference to FIG. 8, when the femtosecond laser processing is completed, the specimen 6 is taken down to observe the surface quality firstly, and then the specimen 6 is placed in an absolute ethyl alcohol solution for ultrasonic cleaning for 5 minutes to remove surface residues. The surface residual stress is measured by X-ray diffraction method. It could be seen that high amplitude compressive residual stress is introduced into the surface of the specimen 6 by means of femtosecond laser, and the compressive residual stress is increased with increase of laser energy.

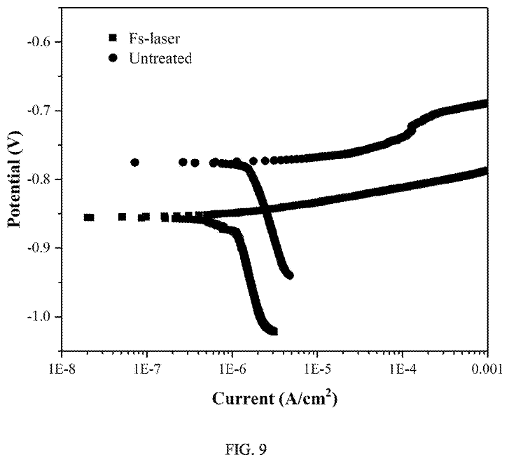

With reference to FIG. 9, electrochemistry corrosion test is performed on the 7075 aluminum alloy specimen 6 before and after femtosecond laser processing. It could be seen from the polarization curve that although the corrosion potential of processed samples decreases, the corrosion current density is less than that of an untreated sample. The corrosion rate of the sample before and after treatment is obtained according to Tafel inverse inference fitting, and results are listed in the Table 1. Compared with a corrosion rate of 0.035 mm·A−1 of the untreated sample, the corrosion rate of the sample subjected to the femtosecond laser treatment is 0.019 mm·A−1, and the corrosion rate is reduced by 45.7%.

TABLE 1
Corrosion performance of aluminum alloy subjected
to femtosecond laser strengthening

| | Corrosion current | Corrosion | Corrosion |
|---|---|---|---|
| | density/A · cm⁻² | potential/V | rate/mm · A⁻¹ |
| Untreated sample | 3.38E−06 | −0.7752 | 0.035 |
| Sample subjected to | 1.79E−06 | −0.8558 | 0.019 |
| femtosecond laser | | | |
| treatment | | | |

With reference to FIG. 8 and FIG. 9, a step-by-step loading method is employed in the fatigue test, initial stress is 200 MPa, stress increment is 20 MPa, the number of cycles is set to be 106, and the stress ratio is 0.1. Five specimens 6 are used for testing in each state, and finally, an average value is taken as a fatigue limit in the state. It could be seen that the high-cycle fatigue limit of untreated specimens 6 is 227±11 MPa. After femtosecond laser strengthening, the fatigue limit reaches 245±8 MPa, which increases by 8% as compared with that of untreated samples.

With reference to FIG. 8 and FIG. 9, a sliding wear test is employed to evaluate the wear performance, a load is 5 N, sliding distance is 5 mm, a friction pair is a GCr15 steel ball with a diameter of 10 mm, a frequency is 5 Hz, and the number of cycles is 10000. A wear volume is measured by using a laser scanning confocal microscope, wear tests are conducted twice for each state, and an average value of the two measurements is taken as a final result. By means of calculation, the wear volume of the specimen 6 before treatment is 11.2×10−3 mm3, and is 7.8×10−3 mm3 after femtosecond laser strengthening, which decreases by 30.4%, thereby achieving improvement on wear performance. In summary, after fs-laser surface processing, the fatigue, wear and corrosion performance are all improved.

The implementation principle of the examples of the strengthening device and the processing method for improving fatigue, wear and corrosion performance of metals of the present application is as follows;

When the femtosecond laser strengthening device is used, an external power supply is first accessed, and then femtosecond laser processing is performed by synergy of the femtosecond laser device 1, the optical transmission module 2, the optical platform 3, the five-axis mobile platform 4, the femtosecond laser processing head 5, and the central processing unit. Firstly, the surface of the specimen 6 is ground and polished, such that surface roughness Ra is reduced to below 0.2, and then the specimen is placed in the absolute ethyl alcohol solution for ultrasonic cleaning for 5 minutes. During femtosecond laser processing, firstly, the femtosecond laser 1 is started for preheating for 15 minutes, where the pulse duration is 290 fs, and the input laser parameters are as follows: the laser energy is 50 μJ, 100 μJ, 150 μJ and 200 μJ, the spot diameter is 15 μm, the repetition is 50 kHz, and the interval of adjacent laser spots is 5 μm. The size data of a processing zone is input into proprietary software, where the rectangular processing zone is 4 cm*2 cm, and the laser scanning path is automatically generated in the system. Then, the specimen 6 is fixed on the processing platform, and the laser focus position is adjusted to the surface of the specimen 6 by controlling the movement of Z axis, such that the starting point of the zone to be processed of the specimen 6 coincides with the position of the red indication light. Then the key of operation is clicked to start femtosecond laser processing, and whether the laser scanning path satisfy an expectation or not is watched during processing.

When femtosecond laser processing is completed, the specimen 6 is taken down to observe the surface quality firstly, and then the specimen 6 is placed in the absolute ethyl alcohol solution for ultrasonic cleaning for 5 minutes to remove the surface residues. The magnitude and distribution of the compressive residual stress on the surface of the processing zone are measured through an X-ray nondestructive testing method. Then, the electrochemical corrosion test is performed on the specimen 6 before and after strengthening to verify the strengthening effect on corrosion performance. Finally, the high-cycle fatigue test is performed on the specimen 6 before and after strengthening, the step-by-step loading method is employed in the test, the initial stress is 200 MPa, the stress increment is 20 MPa, the number of cycles is set to be 106, and the stress ratio is 0.1. Five specimens 6 are used for testing in each state, and finally, the average value is taken as the fatigue limit in each state.

What is claimed is:

1. A strengthening device for improving fatigue, wear and corrosion performance of metals, comprising a femtosecond laser device (1), an optical transmission module (2), an optical platform (3), a five-axis mobile platform (4), a femtosecond laser processing head (5), and a central processing unit (6), wherein the optical platform (3) is fixedly connected to a rear side face of the five-axis mobile platform (4), the femtosecond laser device (1) is fixedly connected to a left side of an upper surface of the optical platform (3), the optical transmission module (2) is mounted on a right side of the upper surface of the optical platform (3), the five-axis mobile platform (4) employs a single-column structure, two linear axes X/Y and two rotating axes A/Z form a carrying platform, the femtosecond laser processing head (5) is mounted on a Z-axis saddle of the five-axis mobile platform (4), a specimen to be processed is arranged below the femtosecond laser processing head (5), and laser scanning processing is completed by means of the synergy of the five-axis mobile platform (4) and a scanning galvanometer in the femtosecond laser processing head (5) under control of the central processing unit.

2. The strengthening device for improving fatigue, wear and corrosion performance of metals according to claim 1, wherein the optical transmission module (2) comprises a beam expander (20), a diaphragm (21), a wave plate (22), a first reflector (23), a second reflector (24), a third reflector (25), and a movable focus lens (26).

3. The strengthening device for improving fatigue, wear and corrosion performance of metals according to claim 1, wherein a scanning galvanometer module (51), a fourth reflector (52), a fifth reflector (53), a laser focus position calibration module (54), and a visual imaging module (55) are integrated inside the femtosecond laser processing head (5).

4. The strengthening device for improving fatigue, wear and corrosion performance of metals according to claim 3, wherein the visual imaging module (55) comprises a charge coupled device (CCD) camera (550), an output end of the CCD camera (550) is connected to an object-side telecentric lens (551) by means of a fixing support, and a band-pass filter (552) is arranged under an output end of the object-side telecentric lens (551).

5. The strengthening device for improving fatigue, wear and corrosion performance of metals according to claim 3, wherein the fourth reflector (52) transmits an annular light source of the fifth reflector (53), and the fourth reflector (52) refracts laser (553) with a working wavelength of 1030 nm.

6. The strengthening device for improving fatigue, wear and corrosion performance of metals according to claim 3, wherein the scanning galvanometer module (51) comprises a first swing motor (510), a second swing motor (512), and a dynamic focus control unit (513).

7. A strengthening method for improving fatigue, wear and corrosion performance of metals, employing the device according to claim 1 and comprising:
S1, before femtosecond laser processing, grinding and polishing a surface of a specimen (6), such that surface roughness Ra is reduced to below 0.2, and then placing the specimen in an absolute ethyl alcohol solution for ultrasonic cleaning for 5 minutes;
S2, during femtosecond laser processing, firstly, starting the femtosecond laser (1) for preheating for 15 minutes, wherein the pulse duration of the femtosecond laser is 290 fs, and input laser parameters are as follows: laser energy is 50 μJ, 100 μJ, 150 μJ and 200 μJ, the spot diameter is 15 μm, the repetition is 50 kHz, and the interval of adjacent light spots is 5 μm; inputting size data of a processing zone into a proprietary software, wherein the rectangular processing zone is 4 cm*2 cm, and a zigzag laser scanning path is automatically generated in a system; then, fixing the specimen (6) on the processing platform, and adjusting a laser focus position to the surface of the specimen (6) by controlling the movement of Z axis, such that a starting point of a zone to be processed of the specimen (6) coincides with the position of a red indication light; then clicking a key of operation, starting femtosecond laser processing, and observing whether the laser scanning path satisfy an expectation or not in a processing process; and
S3, when femtosecond laser processing is completed, taking down the specimen to observe the surface quality, and then placing the specimen (6) in an absolute ethyl alcohol solution for ultrasonic cleaning for 5 minutes to remove surface residues.
